(19) United States
(12) Patent Application Publication
(10) Pub. No.: US 2025/0304753 A1
(43) Pub. Date: Oct. 2, 2025

(54) METHOD OF MANUFACTURE A COMPOSITE MATERIAL, CONSTRUCTION ELEMENTS, AND A CONSTRUCTION UNIT MADE THEREFROM

(71) Applicant: Neovita LLC, Houston, TX (US)

(72) Inventors: Enrique Garcilita Guerrero, Saltillo (MX); Javier Alejandro Todd Gonzalez, Saltillo (MX); Jose Francisco Gonzalez Moncholi, Houston, TX (US)

(73) Assignee: Neovita LLC, Houston, TX (US)

(21) Appl. No.: 19/091,806

(22) Filed: Mar. 26, 2025

Related U.S. Application Data
(60) Provisional application No. 63/570,166, filed on Mar. 26, 2024.

(51) Int. Cl. C08J 5/04; C08K 3/014; C08K 3/26; C08K 5/01; C08K 5/05; C08L 23/06

(52) U.S. Cl. CPC C08J 5/045; C08K 3/014; C08K 3/26; C08K 5/01; C08K 5/05; C08L 23/06; C08J 2323/06; C08K 2003/265; C08L 2205/16; C08L 2207/062

(57) ABSTRACT

The present disclosure relates to a composition and a method for manufacturing a composite material from various natural fiber sources. The disclosure also relates to construction elements and construction kits made of composite fiber material, for use specifically in the development of prefabricated construction systems for building structures such as walls, roofs, and floors. The disclosure further discloses the design and implementation of construction assembly of construction elements and structural profiles that allow for fast and efficient construction of buildings, as well as versatility in the configuration of such structures.

### CROSS REFERENCE TO RELATED APPLICATIONS

The present application is a United States Non-Provisional Patent Application. This Non-Provisional patent application claims priority to the co-pending United States patent provisional application having the Ser. No. 63/570,166, filed Mar. 26, 2024, with confirmation number 7741. United States patent provisional application having the Ser. No. 63/570,166 is incorporated in its entirety by reference.

### TECHNICAL FIELD OF THE DISCLOSURE

The present disclosure relates to a composition and a method for manufacturing a composite material from various natural fiber sources. The disclosure also relates to construction elements and construction kits made of composite fiber material, for use specifically in the development of prefabricated construction systems for building structures such as walls, roofs, and floors. The disclosure further discloses the design and implementation of construction assembly of construction elements and structural profiles that allow for fast and efficient construction of buildings, as well as versatility in the configuration of such structures.

### BACKGROUND OF THE INVENTION

Composite materials are widely used in various industries for their unique properties and applications. This includes the use of fiber parts or layers derived from various natural sources.

In the field of construction, the need for solid and durable buildings is fundamental. However, traditional construction methods often involve laborious and costly processes, which can lead to project delays and increased expenses. In addition, the lack of flexibility in the configuration of structures can be a challenge in terms of adaptability to various design needs and space usage. Further, with growing building construction, reconstruction, and renovation, the present construction systems are not equipped enough to meet the demand, nor there is any system or method available that could expedite the traditional construction systems.

Therefore, an unmet need that the present disclosure aims to meet is to provide a novel composite material made of natural fiber sources, including plant-based fibers (such as jute, hemp, sugarcane, coconut husks, and flax), animal-based fibers (such as wool and silk), and mineral-based fibers (such as basalt) and method of manufacturing the same.

A further unmet need concerns the traditional construction systems, which necessitates focus on finding solutions that could simplify the construction process, reduce costs, and lead times, and at the same time offer versatility in the configuration of structures to meet the growing building construction demand. The different embodiments of the invention disclosed herein satisfy these needs.

### SUMMARY OF THE INVENTION

This section provides a general summary of the disclosure and is not a comprehensive disclosure of the full scope of all its features. The purpose is to introduce the reader to various aspects of art, which may be associated with embodiments of the present invention. This discussion is believed to help and provide the reader with information to facilitate a better understanding of the techniques of the present invention. Accordingly, these statements are to be read in this light, and not necessarily as admissions of prior art.

In one aspect of the present invention, a composition for the composite material is disclosed, wherein the composition comprises coffee husk in a range of 3-74%; high-density polyethylene in a range of 7-45%; calcium carbonate in a range of 2-13%; organic pigment in a range of 0-5%; stearic acid in a range of 0.7-2%; mineral oil in a range of 0-9%; phosphate antioxidants in a range of 0.09-1%; ultraviolet blockers in a range of 0-5% and fire retardant in a range of 0.4-21%.

In yet another aspect, a method for manufacturing composite materials is disclosed. The method comprises dehydrating raw materials comprising selected natural fibers and a matrix material by passing through a rotating hopper at a predefined temperature to remove humidity from the raw materials, followed by grinding the natural fibers by passing the fibers through a mesh sizing, specifically ranging from mesh 15 to mesh 120, to achieve a suitable size for integration.

In an embodiment, moist natural fibers are put into a hopper equipped with an automated temperature and humid control mechanism, wherein the rotating hopper operates at a range of temperature from 150° C. to 250° C. and reduces the moisture content in the fibers. Subsequently, a matrix material is chosen based on the intended application and desired properties of the composite, and the natural fiber components or layers are integrated with the selected matrix material. Finally, the matrix material, embedded with natural fibers, undergoes curing or solidification by applying heat treatment in an autoclave at a predefined temperature for a predefined time to create a resilient and durable composite structure.

In yet another embodiment, a method for preparing plastic material for incorporation into the composite material comprises grinding a selected plastic material with grinding equipment for reducing size with dimensions ranging from mesh 15 to mesh 120 to achieve a suitable size for integration; and adding the ground fibers and additives to the ground plastic material into the composite material.

The present disclosure also relates to a construction element and a kit for construction made from the fiber composite material manufactured using the method discussed above, to provide prefabricated construction systems and elements for building structures such as walls, roofs, and floors.

In one embodiment, the construction element is formed by a body generally in the shape of a straight parallelepiped with a length, a width, and a height, including a first pair of opposite faces, a second pair of opposite faces, and a third pair of opposite faces; a pair of protrusions located on an opposite face of a first pair of opposite faces, defining a longitudinal inlet; and a pair of recesses located on another opposite face of the first pair of opposite faces, defining a longitudinal protrusion, wherein the longitudinal inlet is corresponding to the longitudinal protrusion.

In another embodiment, the kit for constructing a building structure is formed by at least one structural profile, having, on at least one side, a channel; and at least one construction element fitting into the channel of the structural profile, the construction element formed by a body of generally straight parallelepiped shape with a length, a width, and a height, including a first pair of opposite faces, a second pair of opposite faces, and a third pair of opposite faces; a pair of protrusions located on an opposite face of a first pair of opposite faces, defining a longitudinal inlet; and a pair of recesses located on another opposite face of the first pair of opposite faces, defining a protrusion by a longitudinal protrusion, where the longitudinal inlet corresponds to the longitudinal protrusion.

Additional aspects and advantages of the present disclosure will become apparent to those skilled in this art from the following detailed description, wherein only illustrative embodiments of the present disclosure are shown and described. The present disclosure is capable of other and different embodiments, and its several details are capable of modifications in various obvious respects, all without departing from the disclosure. Accordingly, the drawings, descriptions, and examples in this summary are intended for purposes of illustration only and are not intended to limit the scope of the present disclosure.

### BRIEF DESCRIPTION OF THE ILLUSTRATIONS

The characteristic details of the invention are described in the following paragraphs in conjunction with the accompanying illustrations, which are to define the invention, but without limiting the scope thereof.

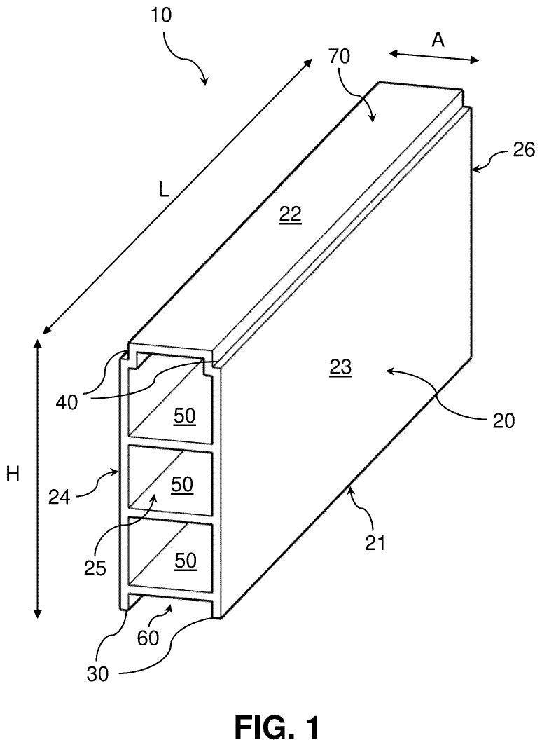

FIG. 1 illustrates a perspective view of a construction element according to an embodiment of the present invention;

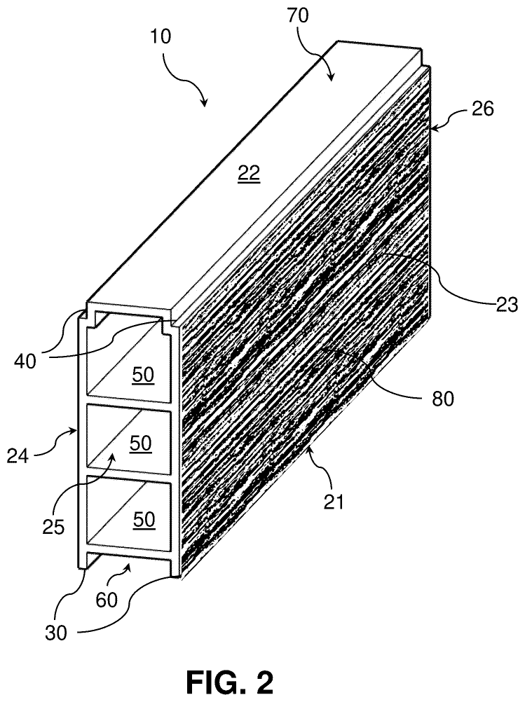

FIG. 2 illustrates a perspective view of a surface-finished building element according to an embodiment of the present invention;

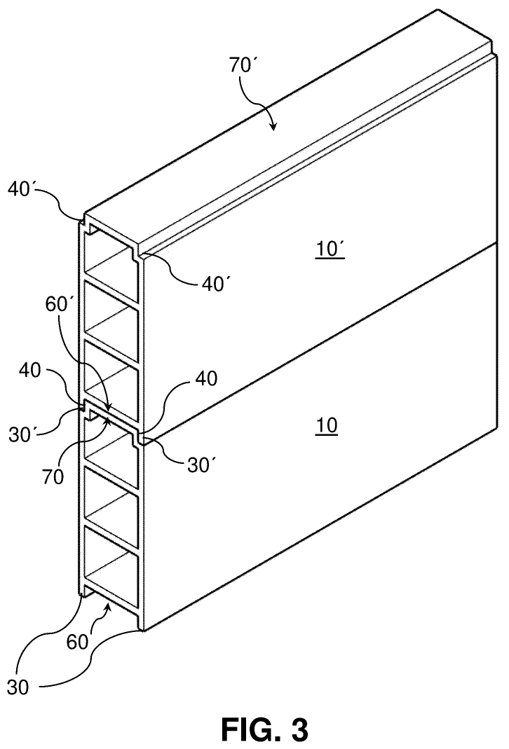

FIG. 3 illustrates a perspective view of a tongue and groove assembly of two construction elements according to an embodiment of the present invention;

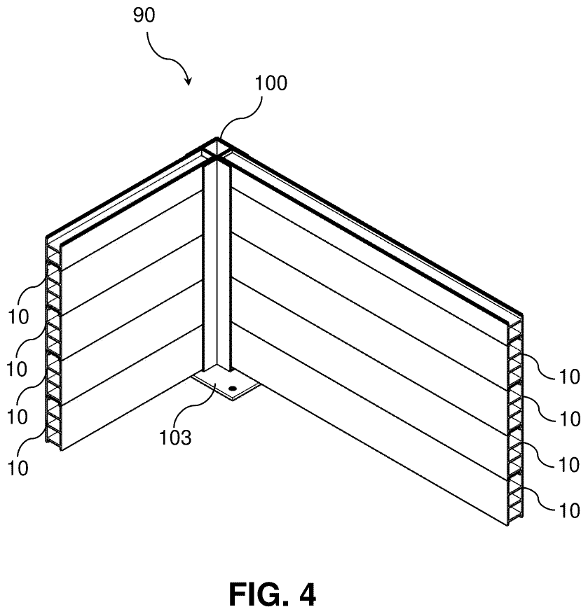

FIG. 4 illustrates a perspective view of a building structure constructed with a kit according to an embodiment of the present invention;

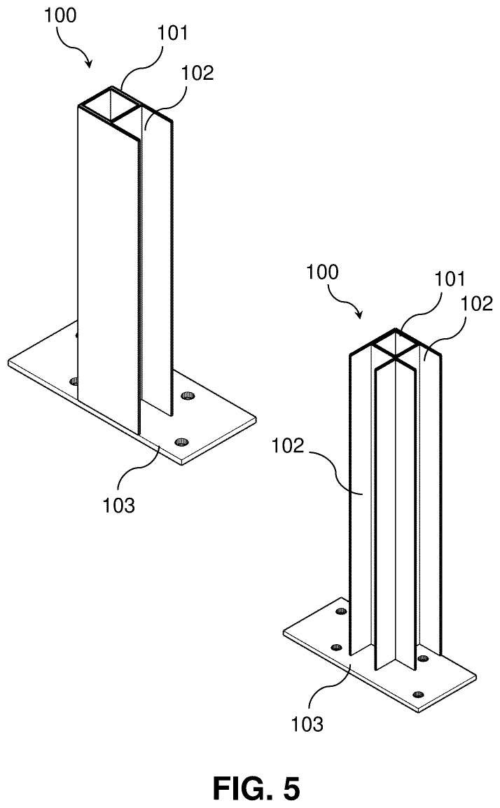

FIG. 5 illustrates a perspective view of two embodiments of a structural profile of the kit for constructing a building structure;

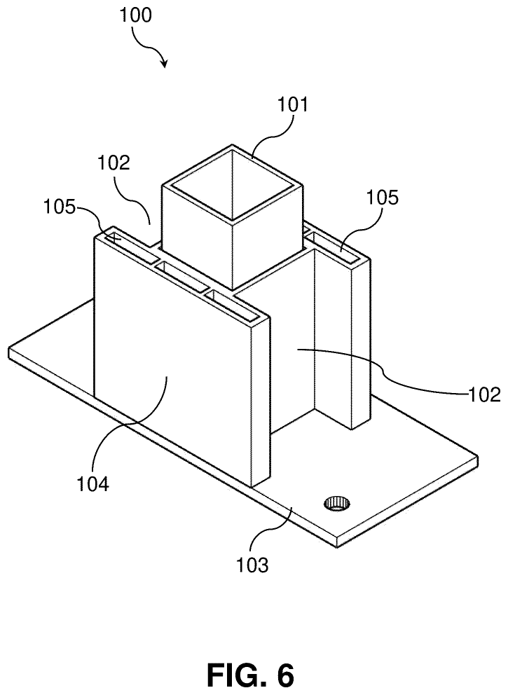

FIG. 6 illustrates a perspective view of a third realization of a structural profile of the kit for constructing a building structure according to an embodiment of the present invention;

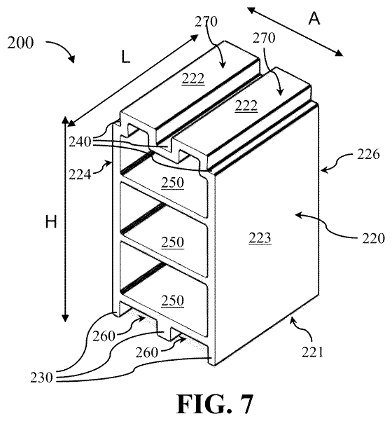

FIG. 7 illustrates a perspective view of a construction element according to another embodiment of the present invention;

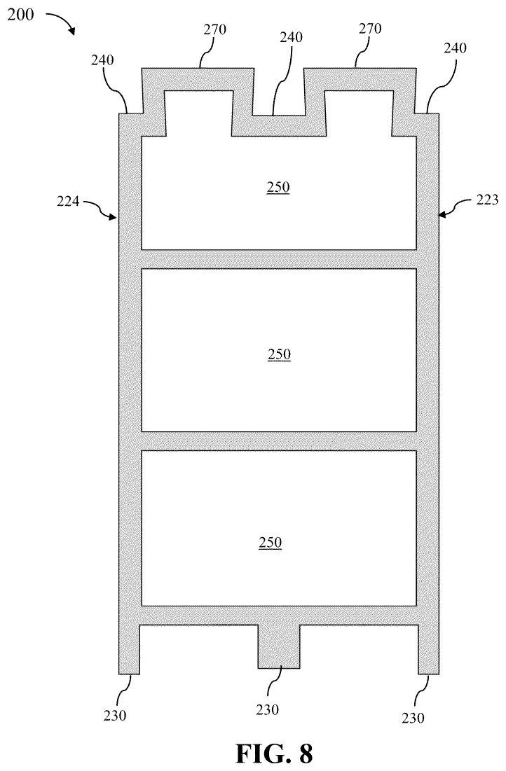

FIG. 8 illustrates a cross-sectional view of the construction element of FIG. 7;

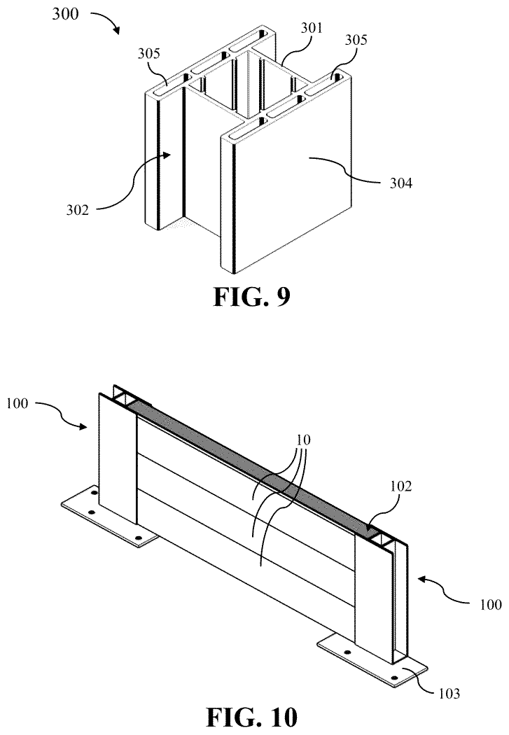

FIG. 9 illustrates an H-Type structural profile according to an embodiment of the present invention;

FIG. 10 illustrates a perspective view of a wall of a building structure constructed with a kit according to another embodiment of the present invention;

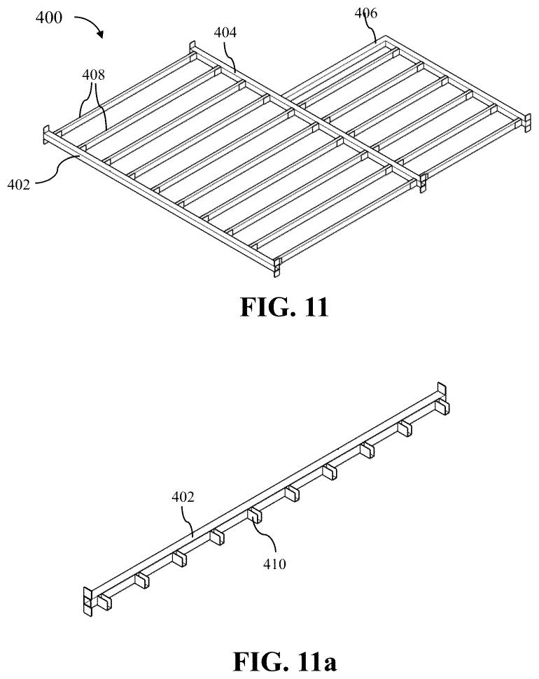

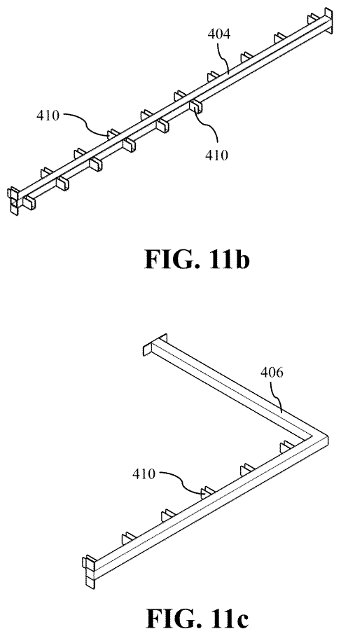

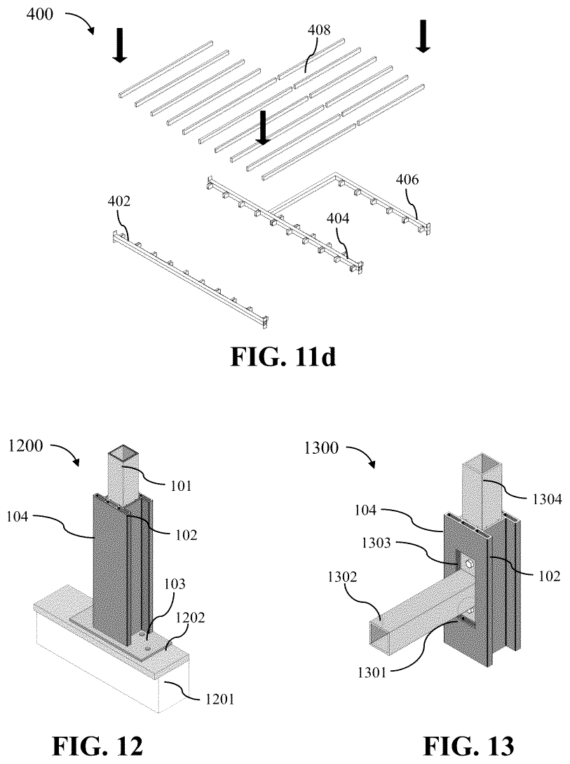

FIG. 11 illustrates an assembled mezzanine system according to an embodiment of the present invention;

FIG. 11a illustrates a PTR profile according to an embodiment of the present invention;

FIG. 11b illustrates a PTR profile according to another embodiment of the present invention;

FIG. 11c illustrates a PTR profile according to yet another embodiment of the present invention;

FIG. 11d illustrates an exploded view of the mezzanine system of FIG. 11, according to an embodiment of the present invention;

FIG. 12 illustrates another embodiment of the H-type structural profile in accordance with an embodiment of the present invention;

FIG. 13 illustrates yet another embodiment of the H-type structural profile in accordance with an embodiment of the present invention;

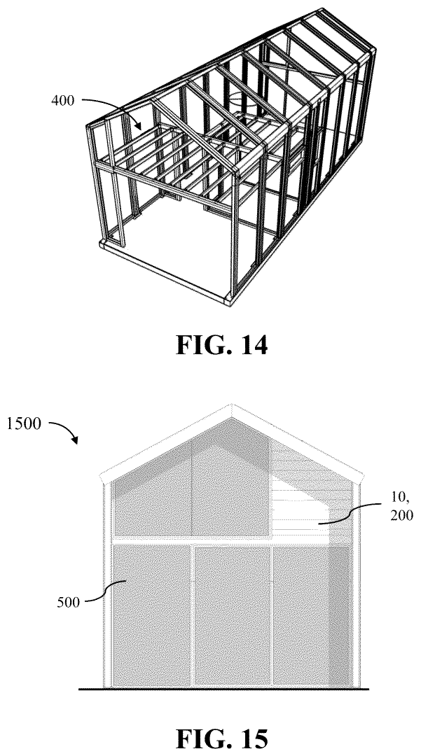

FIG. 14 illustrates a perspective view of the structural composite beams of a building structure, according to an embodiment of the present invention;

FIG. 15 illustrates an exterior front view of a building structure in accordance with the present invention;

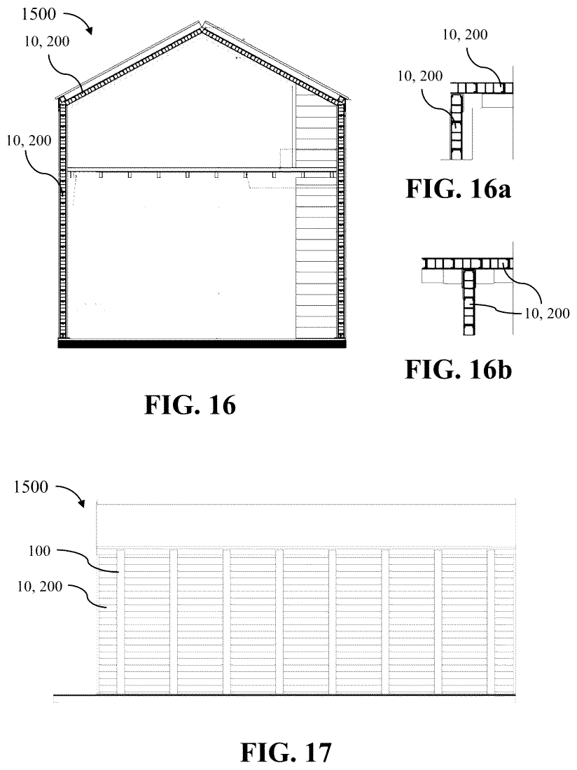

FIG. 16 illustrates a cross-section view of the building structure of FIG. 15 in accordance with the present invention;

FIG. 16a and FIG. 16b illustrate a cross-section view illustrating junctions in building construction in accordance with the present invention;

FIG. 17 illustrates an exterior side view of a building structure in accordance with the present invention;

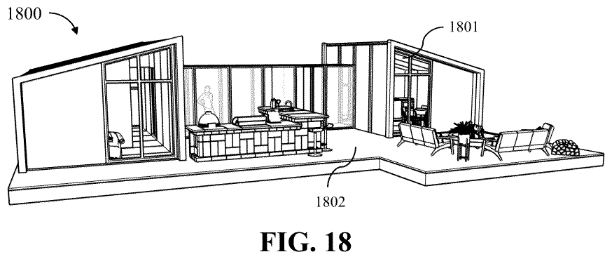

FIG. 18 illustrates yet another building structure in accordance with the present invention;

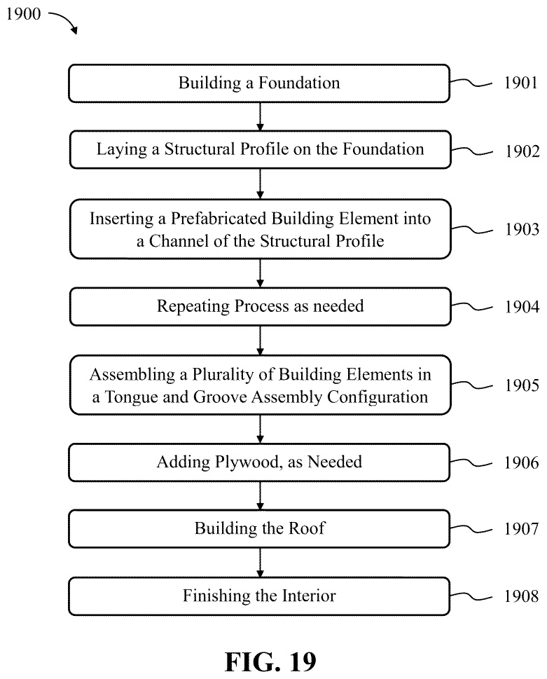

FIG. 19 is a flow chart of a method embodiment.

The drawings are not necessarily to scale and the disclosed embodiments are sometimes illustrated diagrammatically and in partial views. In certain instances, details that are not necessary for an understanding of the disclosed methods and apparatuses, or which render other details difficult to perceive may have been omitted. It should be understood, of course, that this disclosure is not limited to any specific embodiment illustrated herein.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, there is no intention to limit the invention to the specific form disclosed, but, on the contrary, the invention is to cover all modifications, alternative constructions, and equivalents falling within the spirit and scope of the invention as defined in the claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are within the scope of the present claims.

The articles “a” and “an” as used herein mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or specified features and may have a singular or plural connotation depending upon the context in which it is used. The adjective “any” means one, some, or all indiscriminately of whatever quantity.

The drawings are intended to illustrate and disclose presently preferred embodiments to one of skill in the art. The drawings are not intended to be manufacturing-level drawings or renditions of final products. These may include simplified conceptual views to facilitate understanding or explanation. In addition, the relative size and arrangement of the components may differ from that shown and still operate within the spirit of the invention.

Moreover, various directions such as “upper”, “lower”, “bottom”, “top”, “left”, “right”, “first”, “second” and so forth are made only for explanation in conjunction with the drawings. The inventive components may be oriented differently, for instance, during transportation, manufacturing, and operations. Numerous varieties and different embodiments and modifications may be made within the scope of the concept(s) embodiments herein taught and described. Therefore, it is to be understood that the details herein are to be interpreted as illustrative and non-limiting.

An embodiment of the invention disclosed in the present disclosure is to provide a plant-based composite material and a method of manufacturing the same to create a resilient and durable composite structure for use in building construction.

Another embodiment of the present invention is to address the problems of traditional construction systems by developing a tongue and groove assembly system that allows efficient and accurate construction of walls, ceilings, and floors while offering the possibility of adapting the structure according to the needs of the end user.

One more embodiment of the present invention is to provide a kit for constructing a building structure. An additional embodiment of the present invention is to provide a method for constructing a building structure.

In an embodiment, a composition for composite materials discloses plant-based fibers which may be selected from a group consisting of coffee bean husks, hemp, agave, barley, coconut husks, wheat, grapevine, wood, rice husk, sugarcane, cotton husk, seaweed, sawdust, fiberglass, and combinations thereof. Fibers are selected such that the resulting composite material impersonates the aspect and finish of natural wood, whilst imparting mechanical resistance, durability, and sustainability. The resulting composite material can be utilized in various applications, including construction, furniture production, and other wood-based industries, as a high-performance and eco-friendly alternative to traditional wood.

In an embodiment of the present invention, a composition for manufacturing composite materials comprises the processed natural fiber sources in a range of 3%-74% which accounts for 4-50 kg of the natural fiber sources in the resulting composite material. In an embodiment, the coffee husk is present in a range of 30-74%. In yet another embodiment, the coffee husk is present in a range of 20-67%. In one embodiment, the novel chemical formulation features high-density polyethylene (HDPE) as its main constituent. This formulation is designed to provide outstanding flexibility, excellent outdoor durability, and an extended range of usable temperatures. Additionally, the patent investigates alternatives like low-density polyethylene (LDPE) and polypropylene for comparative analysis.

High-density polyethylene (HDPE) is a flexible polymer recognized for its robust properties, including high tensile strength and resistance to various environmental factors. Yet, conventional HDPE formulations face challenges in flexibility, outdoor performance, and temperature range. To address these limitations, new chemical formulations are being explored.

The present invention describes a chemical formulation blending HDPE with carefully chosen additives and modifiers for enhanced properties. The selected additives aim to improve flexibility, boost resistance to outdoor elements (such as UV radiation and weathering), and expand the range of applicable working temperatures, as elaborated below. The resultant composite material retains HDPE's inherent strength while attaining remarkable flexibility and adaptability.

Substitutes for HDPE comprise low-density polyethylene (LDPE) and polypropylene, evaluated for their performance relative to the HDPE-based formulation. The comparative analysis highlights the distinct advantages of the HDPE-based formulation, particularly its suitability for applications demanding flexibility, outdoor resilience, and an extensive working temperature range. HDPE-based formulation is present broadly in the range of 7-45%. In an embodiment, HDPE is present in a range of 7-10%. In yet another embodiment, HDPE is present in a range of 30-45%.

### Calcium Carbonate

In one embodiment, the chemical composition may comprise calcium carbonate as a component to modify plastics. This innovative formulation enhances the impact resistance and fluidity of plastics during the extrusion process.

For various industrial applications, the characteristics of plastics can be altered, such as improving impact resistance and extrusion fluidity, which is beneficial for diverse industrial applications. Calcium carbonate can emerge as a promising additive, owing to its distinctive properties and compatibility with plastics.

One embodiment includes a chemical formulation that combines calcium carbonate with plastics to achieve superior plastic modification. The calcium carbonate acts as a load, providing enhanced impact resistance and facilitating the fluidity of plastics during extrusion. This results in plastics with improved mechanical properties and processing characteristics.

Alternative additives include but are not limited to talc, silica, natural fibers, silicate micas, barite, and combinations thereof. Experience demonstrates the advantages of using calcium carbonate as a modifier, highlighting its potential for a wide range of plastic applications. The present invention utilizes calcium carbonate in a range of 2-13%. In an embodiment, calcium carbonate is present in a range of 2-3%. In yet another embodiment, calcium carbonate is present in a range of 9-13%.

This embodiment can improve the plastics industry by offering a cost-effective and efficient solution for enhancing plastic properties, opening doors to a multitude of applications in manufacturing, packaging, construction, and more.

### Complex Stabilizers

One embodiment pertains to a chemical formulation designed for the stabilization of substances affected by gases produced by vapor-inducing processes. Specifically, the formulation utilizes complex stabilizers to effectively mitigate the adverse effects of gas interactions during various processes.

One embodiment introduces a novel chemical formulation comprising complex stabilizers that are tailored to counteract the destabilizing effects of gases generated from vapor-inducing processes. These stabilizers interact with the gases and prevent their adverse impact on the target substances, maintaining product integrity and process efficiency.

Alternatives to stabilizing agents include but are not limited to metallic salts.

Comparative data is presented to demonstrate the advantages of utilizing complex stabilizers over metallic salts, emphasizing their superior efficacy in stabilizing substances under vapor-induced gas conditions.

The present invention utilizes a complex stabilizer in a range of 0-16%. In an embodiment, the complex stabilizer is present in not more than 3%. In yet another embodiment, complex stabilizers are present in a range of 3-6%.

This embodiment offers significant advancements in the field of chemical stabilization, with applications spanning various industries, including chemical manufacturing, pharmaceuticals, and food processing. It addresses a critical need for effective gas process control, ensuring the quality, safety, and efficiency of industrial processes.

### Organic Pigments

Embodiments to the chemical formulation are designed to enhance the aesthetic properties of products by providing the desired shade or color. Specifically, the formulation utilizes organic pigments to achieve the desired coloration effect, resulting in a wide range of applications across various industries.

Color enhancement is an aspect of product development across industries such as cosmetics, paints, textiles, and plastics. Achieving the desired shade or color is often an important factor in the marketability of these products. Traditionally, organic pigments have been widely employed to provide vibrant and varied colors.

An embodiment introduces an innovative chemical formulation comprising organic pigments as the primary color-enhancing agents. These organic pigments are carefully selected for their ability to deliver the desired shade or color to the product, thereby enhancing its aesthetic appeal. The formulation offers versatility, enabling a broad spectrum of colors to be achieved, catering to the diverse preferences of consumers.

Alternative coloration agents include but are not limited to carbon black and inorganic pigments. While these alternatives can provide coloration, they lack the extensive color palette and vibrancy offered by organic pigments. The present invention utilizes organic pigments in a range of 0-5%. In an embodiment, organic pigment is present in a range of 0.8-1%.

This embodiment improves the field of color enhancement by harnessing the power of organic pigments, allowing for the creation of visually appealing and marketable products. It finds applications in industries where color plays a pivotal role in product differentiation and consumer attraction.

### Fire Retardants

Embodiments of the formulation include a fire-retardant chemical formulation designed for use in plastics to enhance fire safety. Specifically, the formulation works as a highly effective fire retardant, significantly delaying the ignition and combustion of plastic materials, thereby reducing fire hazards.

Fire safety is a critical concern in various industries that utilize plastics in their products. Plastic materials, when ignited, can propagate fires rapidly, posing serious safety risks. Traditional fire retardants often provide limited protection or release harmful gases during combustion. Hence, there is a need for an innovative fire-retardant formulation that can effectively suppress the ignition and combustion of plastics.

In one embodiment, the chemical formulation offers a unique solution to the challenge of fire safety in plastics. It comprises fire retardant agents known for their exceptional performance in delaying the ignition and combustion of plastic materials. The key properties of this formulation may include but it's not limited to Early Retardation, Enhanced Fire Safety, Reduced Toxic Gas Emissions, Broad Applicability, and combinations thereof.

For early retardation, the formulation acts as a retardant right at the beginning of plastic burning. This prevents rapid flame spread and reduces the risk of fire propagation.

For enhanced fire safety, plastics treated with this formulation can exhibit significantly improved fire safety characteristics. Accordingly, this formulation can meet or exceed industry fire safety standards.

For reduced toxic gas emissions: this formulation minimizes the release of toxic gases during combustion, unlike some conventional fire retardants. This can contribute to improved indoor air quality and safety.

For broad applicability, this embodiment is suitable for a wide range of plastic materials. The formulation can accordingly be seamlessly incorporated into various manufacturing processes.

Alternative fire retardants include but are not limited to melamine cyanide, metal hydrates, halogens, and combinations thereof. The present invention utilizes fire retardant in a range of 0-21%. In an embodiment, fire retardant is present in a range of 0.4-5%. This range provides the superior fire-retardant performance of the patented formulation.

Embodiments of this formulation represent a significant advancement in fire safety technology for plastics, offering enhanced protection against fire hazards without compromising the material's integrity or safety. It finds applications in industries where fire safety is paramount, including construction, electronics, and transportation.

### Mineral Oil

In one embodiment, the chemical formulation is designed to improve fluidity and enhance the release of compounds in various applications. Specifically, this formulation incorporates mineral oil as a key component to achieve these desired properties.

In numerous industries, the need for effective lubrication and compound release is crucial to ensure the smooth functioning of machinery and equipment, especially during the formation of compounds. Traditional lubricants, greases, and dry lubricants may not always provide the desired level of fluidity and compound release. Hence, there is a need for an innovative formulation that leverages the unique properties of mineral oil to address these challenges effectively.

This chemical formulation offers a solution to the challenges related to fluidity and compound release. It comprises a carefully balanced combination of mineral oil and other synergistic ingredients. The key properties of this formulation include enhanced fluidity, improved compound release, and versatile applications.

For enhanced fluidity, the inclusion of mineral oil imparts exceptional fluidity to the formulation. This property ensures smooth and consistent distribution in various applications including compound formation.

For improved compound release, the formulation's composition facilitates the efficient release of compounds. This property reduces adhesion and ensures easy separation from surfaces.

For versatile applications, this invention finds applications in a wide range of industries. These industries include but are not limited to machinery, automotive, pharmaceuticals, and food processing, where effective lubrication and compound release are essential.

While mineral oil can be the primary component of the formulation, there are suitable alternatives such as greases and dry lubricants. Embodiments of the formulation represent a significant advancement in the field of lubrication and compound release technology, offering improved fluidity and efficient compound separation without compromising the integrity of the materials involved. It addresses the limitations of conventional lubricants and presents a versatile solution for various industrial applications. The present invention utilizes mineral oil in a range of 0-9%. In an embodiment, mineral oil is present in a range of 0.1-7%. In yet another embodiment, mineral oil is present in a range of 1.7-3%. In an embodiment, stearic acid is present in a range of 0.7-2%. In yet another embodiment, stearic acid is present in a range of 1.4-2%. The present invention utilizes phosphate antioxidants in a range of 0-1%. In an embodiment, phosphate antioxidant is present in a range of 0.09-0.9%. Phenolic antioxidants derived from plant-based compounds enhance

formulation stability by neutralizing free radicals. Additionally, the chelate metal ions improve solubility and dispersibility. Beyond stability, it plays a role in preventing oxidative stress-related disorders. In summary, phenolic antioxidants safeguard formulations and promote overall well-being. The present invention utilizes phenolic antioxidants in a range of 0-5%. In an embodiment, phenolic antioxidants are present in a range of 0.98%. In yet another embodiment, phenolic antioxidants are present in a range of 0.09-1%.

Calcium carbonate, commonly found in limestone, marble, and eggshells, offers several advantages when incorporated into chemical formulations for plastics. It acts as an effective impact modifier, enhancing the plastic's resistance to mechanical stress and preventing brittleness. By reducing viscosity, calcium carbonate enhances plastic flow during extrusion processes. This improved fluidity enables smoother processing and better product quality. Compared to alternatives like talc, silica, natural fibers, silicate micas, and barite, calcium carbonate is cost-effective and readily available. Alternatives to calcium carbonate include talc, silica, natural fibers, silicate micas, barite, and combinations thereof. In summary, calcium carbonate is a versatile additive that enhances both plastic performance and production efficiency. The present invention utilizes calcium in a range of 0-5%. In an embodiment, calcium is present in a range of 0-0.09%. In yet another embodiment, calcium carbonate is present in a range of 2-3%.

Ultraviolet Blockers (UV) blockers can be essential components in chemical formulations, as they can play a crucial role in safeguarding against harmful ultraviolet (UV) radiation. These compounds effectively absorb UV rays, preventing them from penetrating and damaging materials. UV Absorbers directly absorb UV energy, converting it into harmless heat. Common examples include avobenzone and octocrylene1. HALS (Hindered Amine Light Stabilizers) act as radical scavengers, intercepting free radicals generated by UV exposure. By inhibiting degradation reactions, they enhance material longevity. Inorganic filters like zinc oxide and titanium dioxide physically block UV rays by reflecting or scattering them away from the surface. They provide broad-spectrum protection and are often used in sunscreens. In summary, incorporating UV blockers ensures material durability and minimizes solar-induced damage. The present invention utilizes ultraviolet blockers in a range of 0-5%. In an embodiment, the ultraviolet blocker is present in a range of 0.1-1.1%. In yet another embodiment, ultraviolet blockers are present in a range of 0.1-2%.

In an embodiment, the composition of the present invention further comprises at least one additional component chosen from the group consisting of PE wax, calcium, amino crotonate, coupling agent, phenolic antioxidant, polypropylene, low-density polyethylene, PVC, foam regulator, ac foam yellow agent, CPE, white foam agent, and combinations thereof.

PE wax can be derived from ethylene through polymerization and offers a myriad of advantages in chemical formulations. PE wax prevents material sagging during processing. PE Can be used in an anti-settling function as it resists settling in formulations. PE wax enhances material durability and thus provides abrasion resistance. PE wax provides marking resistance as it minimizes surface marking.

Finally, PE wax provides protection against surface damage. In an embodiment, PE wax is less than 0.4 percent of the composition, the calcium is less than 0.09 percent of the composition, the amino crotonate is present in a range of 0-50 percent of the composition, coupling agent is present in a range of 0-4%, the phenolic antioxidant is present in a range of 0-5%, polypropylene is present in a range of 0-3%, low-density polyethylene is present in a range of 0-63%, PVC is present in a range of 0-70%, foam regulator is present in a range of 0-4%, ac foam yellow agent is present in a range of 0-1%, CPE is present in a range of 0-2%, and white foam agent is present in a range of 0.2-1%.

In one embodiment the chemical composition comprises up to 20 percent magnesium hydroxide and preferably up 10 percent magnesium hydroxide and most preferably up to 10 percent magnesium hydroxide. In addition, there is zinc borate of up to 5 percent, preferably 5 percent and most preferably up to 1 percent. The percentages can be reduced from the previously listed other components. Preferably, the percentage of magnesium hydroxide is reduced from the coffee bean husk and the zinc borate percentage is reduced from the recycled plastic. This composition provides improved fire retardancy and improved microbial protection. This composition can be combined with the compounds listed above for Fire Retardants for additional improvement.

This invention represents a breakthrough in sustainable materials, addressing the demand for wood-like products with improved mechanical properties while promoting the responsible use of waste materials from the coffee industry and other sustainable sources.

This invention is poised to revolutionize industries where such properties are critical, including manufacturing, construction, and automotive, by providing a high-performance material capable of meeting diverse and demanding requirements.

### Example 1

A composition for composite materials comprising:
50-74% Coffee Husk,
7-10% High-Density Polyethylene,
2-3% Calcium Carbonate,
0-3% Complex Stabilizer,
0.8-1% Organic Pigment,
0.4-1% Fire Retardant,
0.7-2% Stearic Acid,
0-0.4% PE Wax,
0-0.09% Calcium,
0-50% Amino Crotonato,
0-4% Coupling Agent,
0.1-1.7% Mineral Oil,
0-0.98% Phenolic Antioxidant,
0.09-0.9% Phosphate Antioxidants,
0.1-1.1% UV Blockers,
0-2% Polypropylene,
0-40% Low-Density Polyethylene,
0-70% PVC,
0-4.5% Foam Regulator,
0-0.7% AC Foam Yellow Agent,
0-2.5% CPE, And
0-0.3% White Foam Agent

### Example 2

A composition for [specific purpose] comprising:
20-30% Coffee Husk,
30-45% High-Density Polyethylene,
9-13% Calcium Carbonate,
3-6% Complex Stabilizer,
0.8-1% Organic Pigment,
0.4-1% Fire Retardant,
1.4-2% Stearic Acid,
0% PE Wax,
2-3% Calcium,
0-50% Amino Crotonato,
0% Coupling Agent,
1.7-3% Mineral Oil,
0.09-1% Phenolic Antioxidant,
0.09-0.9% Phosphate Antioxidants,
0.1-2% UV Blockers,
0% Polypropylene,
20-40% Low-Density Polyethylene,
0-70% PVC,
3-4.5% Foam Regulator,
0-0.7% AC Foam Yellow Agent,
2-2.5% CPE, And
0% White Foam Agent.
   Table 1 describes the different potential ranges of the formulas. All the formulas are intended to be within the scope of this invention. A person skilled in the art with the benefit of the disclosure herein would be able to pick the formulation that is best based on the desired properties.

TABLE 1

| | 1 | 2 | 3 | 4 | 5 | 6 | 7 | 8 | 9 | 10 | 11 |
|---|---|---|---|---|---|---|---|---|---|---|---|
| COMPONENTS | % | % | % | % | % | % | % | % | % | % | % |
| Coffee Husk | 74% | 30% | 52% | 52% | 52% | 6% | 3% | 18% | 45% | 40% | 24% |
| High Density | 10% | 45% | 37% | 37% | 37% | 0% | 0% | 0% | 0% | 0% | 0% |
| Polyethylene | | | | | | | | | | | |
| Calcium | 3% | 13% | 6% | 6% | 6% | 0% | 0% | 0% | 0% | 12% | 0% |
| Carbonate | | | | | | | | | | | |
| Complex | 0% | 0% | 0% | 0% | 0% | 3% | 3% | 3% | 3% | 0% | 0% |
| Stabilizer | | | | | | | | | | | |
| Pigment | 1% | 1% | 1% | 1% | 1% | 0% | 0% | 0% | 0% | 1% | 0% |
| (organic) | | | | | | | | | | | |
| Fire | 1% | 1% | 1% | 1% | 1% | 0% | 0% | 0% | 0% | 1% | 1% |
| Retardant | | | | | | | | | | | |
| Stearic acid | 1% | 2% | 0% | 0% | 0% | 0% | 0% | 0% | 0% | 2% | 2% |
| PE Wax | 0% | 0% | 0% | 0% | 0% | 0% | 0% | 0% | 0% | 0% | 0% |
| Calcium | 0% | 3% | 0% | 0% | 0% | 0% | 0% | 0% | 0% | 3% | 3% |
| Amino | 0% | 0% | 0% | 0% | 0% | 36% | 37% | 34% | 28% | 9% | 2% |
| crotonate | | | | | | | | | | | |
| Coupling | 4% | 0% | 0% | 0% | 0% | 0% | 0% | 0% | 0% | 0% | 0% |
| Agent | | | | | | | | | | | |
| Mineral Oil | 0% | 3% | 3% | 3% | 3% | 0% | 0% | 0% | 0% | 2% | 3% |
| Phenolic | 0% | 1% | 0% | 0% | 0% | 0% | 0% | 0% | 0% | 1% | 2% |
| Antioxidant | | | | | | | | | | | |
| Phosphite | 0% | 1% | 0% | 0% | 0% | 0% | 0% | 0% | 0% | 1% | 1% |
| Antioxidant | | | | | | | | | | | |
| UV blockers | 2% | 0% | 0% | 0% | 0% | 0% | 0% | 0% | 0% | 0% | 0% |
| Polypropylene | 3% | 0% | 0% | 0% | 0% | 0% | 0% | 0% | 0% | 0% | 0% |
| Low-Density | 0% | 0% | 0% | 0% | 0% | 0% | 0% | 0% | 0% | 27% | 63% |
| Polyethylene | | | | | | | | | | | |
| PVC | 0% | 0% | 0% | 0% | 0% | 50% | 51% | 37% | 19% | 0% | 0% |
| Foam | 0% | | | | | 3% | 3% | 4% | 3% | 0% | 0% |
| Regulator | | | | | | | | | | | |
| AC foam | 0% | | | | | 0% | 1% | 1% | 1% | 0% | 0% |
| yellow agent | | | | | | | | | | | |
| CPE | 0% | | | | | 2% | 2% | 2% | 2% | 0% | 0% |
| White foam | 0% | | | | | 0% | 0% | 0% | 0% | 0% | 0% |
| agent | | | | | | | | | | | |
| | 100% | 100% | 100% | 100% | 100% | 100% | 100% | 100% | 100% | 100% | 100% |

A method for manufacturing plant-based composite materials is disclosed, comprising several steps to ensure the production of high-quality composites with desirable characteristics. Firstly, the raw materials comprising natural fibers and matrix material are dehydrated. The natural fiber sources are carefully selected from plant-based fibers, animal-based fibers, and mineral-based fibers. These natural fiber sources are chosen based on their ability to provide the desired attributes in the final composite material, such as strength, flexibility, and durability.

### Dehydrate Raw Materials

In one embodiment, a method for dehydrating raw materials in the manufacturing of composite materials is disclosed. The raw materials, which may include natural fiber sources and matrix materials, are subjected to a dehydration process to eliminate any humidity present. This process enhances the suitability of the raw materials for further processing and integration into the composite material.

In one embodiment of the dehydration process, a rotating hopper is utilized. The rotating hopper operates at high temperatures, creating an environment conducive to the removal of humidity from the raw materials. The raw materials are loaded into the hopper, where they are exposed to elevated temperatures. The rotation of the hopper ensures that the raw materials are evenly heated, facilitating uniform dehydration.

The dehydration process aims to optimize the quality and performance of the composite material by eliminating moisture, which can negatively affect the properties of the final product. By dehydrating the raw materials, the composite material can exhibit enhanced mechanical characteristics, improved durability, and a more uniform structure.

The utilization of a rotating hopper in the dehydration process offers several advantages. Firstly, the high-temperature environment created by the hopper ensures efficient and thorough dehydration of the raw materials. Secondly, the rotation of the hopper promotes uniform heating, preventing localized overheating or underheating of the raw materials. This ensures consistency in the dehydration process and contributes to the overall quality of the composite material.

In various embodiments, the disclosed dehydration process finds utility in various industries, including but not limited to construction and composite material production. Its application in these industries contributes to improved product quality, efficiency, and performance. The use of a rotating hopper operating at high temperatures offers an innovative solution for effectively removing humidity from raw materials, thereby enhancing the suitability of the materials for integration into composite materials.

### Grinding and Homogenization

In one embodiment, the present invention encompasses a method for manufacturing composite materials, wherein the fibers undergo a grinding process to achieve a finely reduced size. The grinding process involves passing the fibers through different mesh sizes, specifically ranging from mesh 15 to mesh 120. To achieve the desired result, various knives and grinders are employed in the mills during the grinding process.

The purpose of the grinding process is to ensure that the fibers are reduced to a suitable size for integration into the composite material. The fibers are passed through different mesh filter sizes, the method allows for the customization of the fiber size, depending on the specific requirements of the composite material. The mesh size can be at least 5 and no more than 200, preferably at least 10 and no more than 150 and most preferably at least 80 and no more than 100.

During the grinding process, the fibers are subjected to the action of knives and grinders within the mills. These tools effectively break down and reduce the size of the fibers, ensuring a homogenous distribution within the composite material. The selection of the appropriate knives and grinders is crucial in achieving the desired result, as different fiber types may require specific tools for optimal grinding.

It should be noted that the grinding process is an essential step in the manufacturing of composite materials, as it contributes to the overall quality and performance of the final product. The finely reduced fibers obtained through the grinding process enhance the interaction between the fibers and the matrix material, resulting in a composite material with improved mechanical characteristics and overall durability.

In various embodiments, the grinding and homogenization process involves the reduction of fiber size using various knives and grinders in the mills. This process ensures a finely reduced size of the fibers, allowing for their effective integration into the composite material. The finely reduced size can be from a mesh 20 to mesh 150. The grinding process, along with subsequent steps in the manufacturing process, contributes to the overall quality and performance of the resulting composite material.

### Drying Process

The drying process integrates automation using a hopper equipped with advanced temperature control mechanisms. The hopper system provides an efficient and consistent means of drying moist fibers. The fibers are loaded into the hopper, where temperature control ensures that the drying environment is optimized for the specific fiber type and moisture content. The automated process reduces labor requirements and ensures precision in the drying process.

The selected natural fibers are loaded into a hopper for drying moist fibers. The hopper is equipped with an automated temperature and humid control mechanism, wherein the rotating hopper operates at a range of temperature from 150° C. to 250° C. and reduces the moisture content in the fibers.

This system utilizes sensors and control mechanisms to monitor and adjust environmental conditions, such as temperature, humidity, and airflow, to optimize the drying process. The automated drying system offers increased efficiency, consistency, and precision in drying moist fibers, ensuring that the fibers are dried thoroughly and uniformly before further processing and integration into the composite material. This automated approach also reduces the labor and time required for drying, enhancing overall productivity in the manufacturing process.

In addition to the automated approach, an alternative manual approach using shovels can also be employed. The moist fibers are handled and exposed to controlled environmental conditions conducive to drying. This manual drying method allows for flexibility and adaptability in different settings, ensuring that the fibers are effectively dried to remove any moisture. The use of shovels enables the fibers to be spread out, enhancing their exposure to air and controlled temperatures, resulting in efficient moisture reduction. This manual drying method allows for flexibility and adaptability in different settings.

Both the manual and automated drying methods aim to achieve effective moisture reduction in fibers, enhancing their suitability for various applications. The controlled drying process not only ensures the removal of moisture but also contributes to the preservation of fiber quality and characteristics. To effectively reduce the moisture content in the fibers, environmental conditions need to be controlled by temperature and humidity optimization. The manual method utilizes the shovels to handle and expose the moist fibers to the controlled environmental conditions conducive to drying. In the case of utilizing the automated method, the moist fibers are loaded into a rotating hopper equipped with advanced temperature and moisture control mechanisms. The rotating hopper allows uniform heating of raw materials. Further, advanced temperature and moisture control mechanism optimizes the environment for drying within the hopper based on the types of fiber. For precise temperature regulation, the advanced temperature control mechanisms include sensors and controllers. Said automated method allows enhanced precision as it reduces the need for labor.

This drying process finds utility in a wide range of industries, including construction, and composite material production. Its versatility and adaptability make it a valuable addition to fiber processing and manufacturing processes, contributing to improved product quality and efficiency.

The disclosed drying process offers innovative solutions for moisture reduction in fibers, providing flexibility through manual methods and precision through automated systems. Its application extends across industries, addressing the need for effective fiber drying in various settings.

Once the natural fibers are passed through the rotating hopper to reduce the moisture content in the fibers, the extraction and processing of these fibers takes place. This involves cleaning, sizing, and refining the fibers to ensure uniformity and quality. The extraction and processing stage is crucial in preparing the natural fibers for integration into the composite material.

In parallel a matrix material is chosen based on the intended application and the desired properties of the composite. The matrix material, which can be a polymer or resin, plays a critical role in binding the natural fiber components together and providing structural integrity to the composite.

After the selection of the matrix material, the next step is to integrate the processed natural fiber components or layers with the chosen matrix material. Various techniques for extraction and processing of the natural fibers are employed, such as impregnation, weaving, or layering to ensure a strong interaction between the fibers and the matrix. These techniques are selected based on the specific requirements of the composite and the desired properties to be achieved.

Once the natural fiber components or layers are integrated with the matrix material, the composite material takes form. This is achieved through the curing or solidifying of the matrix material, which incorporates the embedded natural fibers to generate a resilient and durable structure. The curing process may involve heat treatment or other suitable methods to promote the desired characteristics of the composite material.

The method of manufacturing composite materials described herein offers several advantages. By utilizing a wide array of natural fiber sources, the method promotes sustainability and reduces environmental impact. Furthermore, the resulting composite material exhibits enhanced mechanical characteristics, lightweight attributes, and biodegradability, depending on the choice of natural fibers. These properties make the composite material suitable for various applications, including construction, automotive, aerospace, and beyond.

### Composite Materials

Composite materials are utilized across industries due to their distinct characteristics. In a specific embodiment, this invention focuses on a novel approach to manufacturing composite materials, utilizing fiber parts or layers sourced from diverse natural origins. In a more specific embodiment, a method is described for crafting composite materials through the following steps:

The process commences with the meticulous selection of natural fiber sources, encompassing plant-based fibers like jute, hemp, coconut husks, sugarcane, and flax, animal-based fibers such as wool and silk; and mineral-based fibers like basalt. This selection is predicated on achieving the desired attributes in the final composite material. The chosen natural fibers undergo extraction and processing to acquire suitable fiber components or layers. This process may entail cleaning, sizing, and refining the fibers to ensure uniformity and quality. Said process enhances their compatibility and mechanical properties in the final composite material. The cleaning of the natural fiber aids in removing impurities and foreign matter.

The selection of an appropriate matrix material, such as a polymer or resin, is contingent upon the intended application and the desired properties of the composite. A thermosetting polymer material is selected as the polymer matrix material which is allowed to undergo cross-linking during curing which involves heat treatment. Said heat treatment is given in an autoclave. The integration of the extracted/processed natural fiber components or layers with the matrix material involves impregnation, weaving, or layering techniques. Said weaving technique employs automated machinery to create a resilient and durable composite structure.

The extracted natural fiber components or layers are integrated with the chosen matrix material. Various techniques, including impregnation, weaving, or layering, are employed to ensure a robust interaction between the fibers and the matrix. For weaving, automated machinery is utilized. The composite material takes form through the curing or solidifying of the matrix material, incorporating the embedded natural fibers to generate a resilient and durable structure. The curing process may involve heat treatment or other suitable methods to promote the desired characteristics of the composite material. Said heat treatment can be given in an autoclave. During the curing process, cross-linking of thermosetting polymer matrix material is done.

The method provides the advantage of leveraging a wide array of natural fiber sources, promoting sustainability, and mitigating environmental impact. The resultant composite material exhibits enhanced mechanical characteristics, lightweight attributes, and biodegradability, contingent upon the choice of natural fibers. This method promotes sustainability by reducing the environmental impact of composite material production and tailoring. Further, the biodegradability of the resulting composite material can be tailored with the selection of natural fibers which enhances the ecological compatibility.

In various embodiments, this method for crafting composite materials from diverse natural fiber sources presents a sustainable and versatile solution applicable in numerous fields, including construction, automotive, aerospace, and beyond.

In an embodiment, a method for preparing plastic material for incorporation into the plant-based composite material comprises grinding a selected plastic material with grinding equipment to reduce size with dimensions ranging from mesh 15 to mesh 120 to achieve a suitable size for integration; and adding the ground fibers and additives to the ground plastic material into the composite material.

### Plastic Selection

Before use, the plastic material can undergo testing to ascertain its suitability for incorporation into the composite material. The testing process shall include evaluating the physical and chemical properties of the plastic material to ensure compatibility with the desired attributes of the composite material. The testing shall be conducted by qualified professionals utilizing industry-standard testing methods and equipment. The plastic material shall be subjected to various tests, including but not limited to tensile strength, impact resistance, thermal stability, and chemical compatibility. The results of the testing shall be documented and retained as part of the patent owner's records. Only plastic materials that meet the predetermined criteria for suitability shall be selected for integration into the composite material. Any plastic material found to be unsuitable during the testing process shall be rejected and alternative materials shall be considered. The rigorous testing process aims to ensure that only high-quality plastic materials are used, thereby enhancing the overall performance and durability of the composite material. The assessment of material thermal stability ensures the plastic can endure the necessary temperature conditions for its intended use. Industry-standard testing methods and equipment, following ASTM or ISO standards, guarantee the reliability and consistency of the evaluation process.

### Grinding Plastic

Should the plastic material arrive in larger pieces than required, it can be ground into smaller pieces to facilitate proper mixing with the fibers and additives. The purpose of grinding the plastic material is to achieve a suitable size for integration into the composite material, ensuring a homogenous distribution within the final product. This grinding process involves breaking down and reducing the size of the plastic material using appropriate equipment, such as grinders or mills. The selection of the grinding equipment is crucial to ensure optimal results, as different types of plastic may require specific tools for effective grinding. In one embodiment, the size of the plastic should be from 0.0039 to 1.5 inches. The plastic could be in pellet, crushed plastic, or leaflet form. By reducing the size of the plastic material, it becomes easier to mix with the fibers and additives, promoting uniformity and enhancing the overall quality and performance of the composite material.

### Measurement of Component Weight

Before depositing all the materials into the hopper, a step of accurately measuring the weight of each component can be conducted to ensure the correct formulation of the composite materials. This measurement process aims to achieve precise proportions of the natural fiber sources and the matrix material, such as a polymer or resin, to obtain the desired attributes and properties in the final composite material. The accurate measurement of component weight contributes to the consistency and quality of the manufacturing process, ensuring that the composite materials are formulated following predetermined criteria. The measured weights of each component shall be recorded and retained as part of the records, serving as evidence of the proper formulation of the composite materials. Artificial Intelligence (AI) and Machine Learning (ML) would improve the process over time.

With reference to FIG. 1, a perspective view of construction element 10 according to the present invention is shown. The construction element 10 includes a body 20, a pair of protrusions 30, and a pair of rabbets 40.

Body 20 has a generally straight parallelepiped shape having a length L, a width A, and a height H. Body 20 includes a first pair of opposing faces 21 and 22, a second pair of opposing faces 23 and 24, and a third pair of opposing faces 25 and 26. Alternatively, body 20 may incorporate at least one conduit 50 traversing its entire length L.

The conduit 50 may have any cross-sectional configuration, such as square, triangular, round, circular, oval, or polyhedral, among others. In addition, the conduit 50 may be filled with a thermally insulating material. Examples of thermally insulating materials include, but are not limited to, polyurethane foam, expanded or extruded polystyrene, expanded perlite, fiberglass, cork, mineral wool, wood shavings, sawdust, straw, and combinations thereof.

The pair of protrusions 30 is on the opposite face 21 of the first pair of opposite faces 21 and 22, defining a longitudinal inlet 60, while the pair of rabbets 40 is on the opposite face 22 of the first pair of opposite faces 21 and 22, defining a longitudinal protrusion 70. This pair of rabbets 40 corresponds to the pair of protrusions 30 so that the longitudinal inlet 60 corresponds to the longitudinal protrusion 70. Both the pair of protrusion 30 and the pair of rabbets 40 are continuous and extend along the length L of the body 20. Alternatively, they can be discontinuous, alternating discontinuity so that there is correspondence between the pair of protrusions 30 and the pair of rabbets 40. The longitudinal inlet 60 and the longitudinal protrusion 70 are rectangular in cross-section.

The construction element 10 may be made of thermoplastic material or a mixture of such thermoplastic material with cellulose fibers. Examples of thermoplastic materials include, but are not limited to, include polyethylene, cross-linked polyethylene, high-density polyethylene, low-density polyethylene, polyethylene terephthalate, polystyrene, high-impact polystyrene, homopolymer polypropylene, copolymer polypropylene, random copolymer polypropylene, polybutylene, vinyl polychloride, chlorinated vinyl polychloride, polyvinylidene fluoride, acrylic polymers, nylon, thermoplastic polyurethane, polycarbonates, acrylonitrile butadiene styrene, polytetrafluoroethylene, polymethylmethacrylate and combinations thereof. Examples of cellulose fibers include but are not limited to, wastepaper, rice straw, corn stalks, millet stalks, hemp, coconut husks, rice husks, coffee husks, cocoa husks, coconut exocarp, coconut mesocarp, coconut endocarp, sugarcane bagasse, sawdust, wheat bran, mango peel, peanut shells, and combinations thereof.

In this embodiment, construction element 10, being made of thermoplastic material and having a defined and fixed cross-section, can be of any color or shade and be produced by a thermoplastic material extrusion process through an extruder machine. In this way, the construction element 10, as it is extruded, can be cut to any length L to obtain panels or blocks.

In an alternative embodiment, as shown in FIG. 2, the construction element 10 has a surface finish 80 on at least one opposite face of the second pair of opposite faces 23, 24. This surface finish 80 may be roughened, smooth, glossy, polished, brushed, wood, marble, concrete, or textile finish, among others. Such surface finish 80 may be achieved by a surface brushing or roughing process, a hot stamping process, or a laser printing process applied to at least one opposite face of the second pair of opposite faces 23, 24. This surface finish 80 applied to the construction element 10 allows a building structure, as described below, to be made with a plurality of construction elements 10 to acquire an ornamental appearance, both internally and externally, according to the taste of the users.

Now in FIG. 3, a perspective view of a tongue and groove assembly of two construction elements 10 and 10′ according to the present invention is shown. To create a building structure, whether a wall, roof, or floor, it is necessary that at least a first-construction element 10 and a second-construction element 10′ fit together in a tongue and groove assembly, wherein the longitudinal protrusion 70 of the first-construction element 10 fits into the longitudinal inlet 60′ of the second construction element 10′. In this manner, each protrusion of the pair of protrusions 30′ of the second construction element 10′ marries with the corresponding recess of the pair of rabbets 40 of the first construction element 10. This process can be repeated successively with “n” construction elements (not shown) wherein each longitudinal protrusion of the construction element being placed engages the longitudinal protrusion of the construction element previously placed in the assembly until a user-desired wall height or ceiling or floor area is reached in the building structure.

Turning to FIGS. 4, 5, and 6, a perspective view of a building structure 90 assembled with a kit for construction is shown, and a view in perspective of two embodiments of a structural profile 100 of the kit for construction according to the present invention, respectively. The building structure 90 is formed by at least one construction element 10 and at least one structural profile 100.

As shown in FIG. 5, the structural profile 100 may be made of metallic material and comprises a structural body 101 having a square or rectangular cross-section, possessing, on at least one side, a channel 102. Alternatively, the structural profile 100 includes an anchoring base 103. Channel 102 has a square or rectangular cross-section, with an opening coincident with the width A of the construction element 10, so that the construction element 10 fits into channel 102.

In an alternative embodiment, as shown in FIG. 6, the structural profile 100 comprises a structural body 101 having a square or rectangular cross-section, made of metallic material, and includes an anchor base 103, such structural body 101 being surrounded or enclosed by a wrapping structure 104 having, on at least one side, a channel 102 with a square or rectangular cross-section, with an opening coincident with the width A of the construction element 10, so that the construction element 10 fits into the channel 102.

The wrapping structure 104 is made of the same thermoplastic material or a mixture of thermoplastic material with cellulose fibers, from which construction element 10 is made. In this embodiment, the wrapping structure 104, being made of thermoplastic material and having a defined and fixed cross-section, can be of any color or shade and be produced by a thermoplastic material extrusion process. Typically, the thermoplastic material extrusion process is through an extrusion process in an extrusion machine, being co-extruded onto the structural body 101 and subsequently undergoing a surface finish such as those previously indicated for the construction element 10. Through this process, the wrapping structure 104 allows the structural profile 100 to have the same color and a surface finish as the construction elements 10 it supports.

Additionally, the wrapping structure 104 includes one or more structure conduits 105 may have any cross-sectional configuration, such as square, triangular, round, circular, oval, or polyhedral, among others. In addition, the structure conduit 105 may be filled with a thermally insulating material, such as those noted above, to provide thermal qualities to the structural profile 100.

The building structure 90, as shown in FIG. 4, is a pair of walls arranged at 90°, constructed using a plurality of construction element 10 stacked in a tongue and groove assembly as described above. Both walls are embedded and supported in channel 102 of structural profile 100, which acts as a column. Structural profile 100 is anchored to a foundation or platform through anchor base 103. However, one skilled in the art will recognize the possibility of positioning the structural profile 100 so that it functions as a foundation slab or structural beam for constructing a building structure 90 as floor or ceiling.

The invention has its application in the field of the prefabricated construction industry, so that, in line with what has been described above, the advantage of the present invention lies in the efficiency and speed of the assembly process. By using tongue-and-groove construction elements and structural profiles designed specifically for this purpose, the task of erecting walls, roofs, and floors in a building structure is significantly simplified. This efficiency translates into time and cost savings, which is especially beneficial for both large-scale projects and residential construction. In addition, the precision of precast elements contributes to higher quality and consistency in the final construction, which is also a key advantage in terms of the durability and stability of the structure.

FIG. 7 illustrates a perspective view of a construction element 200 according to an alternative embodiment of the present invention. The construction element 200 includes a body 220 having a generally straight parallelepiped shape having a length L, a width A, and a height H. Body 220 includes a first pair of opposing faces 221 and 222, a second pair of opposing faces 223 and 224, and a third pair of opposing faces 225 and 226. Alternatively, body 220 may incorporate at least one conduit 250 traversing its entire length L. as shown in FIG. 7, the body 220 of the construction element 200 includes three conduits 250.

Conduit 250 may have any cross-sectional configuration, such as square, triangular, round, circular, oval, or polyhedral, among others. In addition, the conduit 250 may be filled with a thermally insulating material. Examples of thermally insulating materials include, but are not limited to, polyurethane foam, expanded or extruded polystyrene, expanded perlite, fiberglass, cork, mineral wool, wood shavings, sawdust, straw, and combinations thereof.

The face 221 of the first pair of opposite faces 221 and 222 includes three protrusions 230, defining a pair of longitudinal inlets 260. The face 222 of the first pair of opposite faces 221 and 222 includes three rabbets 240 defining a pair of longitudinal protrusion 270. Said rabbets 240 correspond to the protrusions 230 so that the pair of longitudinal inlets 260 corresponds to the pair of longitudinal protrusion 270. Said protrusion 230 and the rabbets 240 are continuous and extend along the length L of the body 220. Alternatively, they can be discontinuous, alternating discontinuity so that there is correspondence between the protrusions 230 and the rabbets 240. The pair of longitudinal inlets 260 and the pair of longitudinal protrusion 270 are rectangular in cross-section.

The construction element 210 can be made of thermoplastic material or a mixture of such thermoplastic material with cellulose fibers. Examples of thermoplastic materials include, but are not limited to, include polyethylene, cross-linked polyethylene, high-density polyethylene, low-density polyethylene, polyethylene terephthalate, polystyrene, high-impact polystyrene, homopolymer polypropylene, copolymer polypropylene, random copolymer polypropylene, polybutylene, vinyl polychloride, chlorinated vinyl polychloride, polyvinylidene fluoride, acrylic polymers, nylon, thermoplastic polyurethane, polycarbonates, acrylonitrile butadiene styrene, polytetrafluoroethylene, polymethylmethacrylate and combinations thereof. Examples of cellulose fibers include but are not limited to, wastepaper, rice straw, corn stalks, millet stalks, hemp, coconut husks, rice husks, coffee husks, cocoa husks, coconut exocarp, coconut mesocarp, coconut endocarp, sugarcane bagasse, sawdust, wheat bran, mango peel, peanut shells, and combinations thereof.

In this embodiment, construction element 210, being made of thermoplastic material and having a defined and fixed cross-section, can be of any color or shade and be produced by a thermoplastic material extrusion process through an extruder machine. In this way, the construction element 210, as it is extruded, can be cut to any length L to obtain panels or blocks.

The construction element 210, as shown in FIG. 7, can have a surface finish on at least one opposite face of the second pair of opposite faces 223, 224, similar to that of one embodiment of the construction element 10, as shown in FIG. 2 of the present invention.

In an embodiment, a plurality of construction elements 210 can be assembled in a tongue and groove configuration for the creation of the building structure, in a similar manner to the construction elements 10, as shown in FIG. 3.

FIG. 8 illustrates a cross-sectional view of the construction element of FIG. 7 with similar elements given the same reference numeral.

FIG. 9 illustrates an H-Type structural profile 300 with a central opening for steel reception and sidebars. The H-Type structural profile 300 comprises a structural body 301 having a square or rectangular cross-section, made of metallic material, and, such structural body 301 is surrounded or enclosed by a wrapping structure 304 having, on at least one side, a channel 302 with a square or rectangular cross-section, with an opening coincident with the width A of the construction element 10, 200, so that the construction element 10, 200 fits into the channel 302.

In this embodiment, the wrapping structure 304, being made of thermoplastic material and having a defined and fixed cross-section, can be of any color or shade and be produced by a thermoplastic material extrusion process. Typically, the thermoplastic material extrusion process is through an extrusion process in an extrusion machine, being co-extruded onto the structural body 301 and subsequently undergoing a surface finish such as those previously indicated for the construction element 10, 200. Through this process, the wrapping structure 304 allows the H-Type structural profile 300 to have the same color and a surface finish as the construction elements 10, 200 it supports.

Additionally, the wrapping structure 304 includes one or more structure conduits 305 may have any cross-sectional configuration, such as square, triangular, round, circular, oval, or polyhedral, among others. In addition, the structure conduit 305 may be filled with a thermally insulating material, such as those noted above, to provide thermal qualities to the H-Type structural profile 300.

FIG. 10 illustrates a perspective view of a wall of a building structure constructed with a kit according to another embodiment of the present invention. the anchoring base 103 of the structural profile 100 of the kit for construction is screwed to the foundation to provide rigid support. As shown, construction element 10 is fitted into channel 102 of the structural profile 100. Further, as shown, the successive construction elements 10 are assembled in a tongue and groove assembly creating a wall for the building structure.

FIG. 11 illustrates an assembled mezzanine system 400, in accordance with the present invention. The mezzanine system 400 includes PTR (Profiled Tube Rectangular) profiles assembled together to receive a plurality of loading element 408 in a rigid manner. FIGS. 11a-11c illustrate various designs of profiles that are used in the assembly of the mezzanine system 400. FIG. 11a illustrates a PTR profile 402 that includes a plurality of U-type clips 410 welded along a full length on only one side of the PTR profile 402. FIG. 11b illustrates another PTR profile 404 that includes a plurality of U-type clips 410 welded along a full length on one side and along a partial length on the other opposite side of the PTR profile 402. FIG. 11a illustrates a corner PTR profile 406 that includes a plurality of U-type clips 410 welded along an inner length of one arm of the corner PTR profile 406.

FIG. 11d illustrates an exploded view of the mezzanine system as shown in FIG. 11, according to an embodiment of the present invention. The PTR profiles 402, 404, and 406 are placed according to their design configuration to receive a plurality of loading elements 408, wherein the placement is such that the plurality of U-type clips 410 on the PTR profile 402 faces the plurality of U-type clips 410 on one side of the PTR profile 404, and the plurality of U-type clips 410 on the other side of the PTR profile 404 faces the plurality of U-type clips 410 on the inner arm of the corner PTR profile 406. This arrangement forms a pair of U-type clips 410 which face each other, wherein loading element 408 can be received in each of said pair of U-type clips 410.

FIG. 12 illustrates an H-type structural profile 1200 embodiment with a steel bar structural body 101 for constructing a building structure in accordance with the present invention. Foundation 1201 can be made of a wood beam with floor 1202 made of plywood. Anchor base 103 of the structural profile 1200 is anchored to the foundation 1201. The structural body 101 of the structural profile 1200 is surrounded or enclosed by a wrapping structure 104 having on at least one side, a channel 102 with a square or rectangular cross-section, with an opening coincident with the width A of the construction element 10, 200.

FIG. 13 illustrates another embodiment of the H-type structural profile 1301 with a hollow section 1303 cut on the wrapping structure 104 to allow a cross beam 1302 to connect perpendicular to the vertical beam 1304. In an embodiment, the H-type structural profile 1301 is used for connecting the PTR profile 402, 404, 406 of FIGS. 11, 11a-d, for building upper floors.

FIG. 14 illustrates a perspective view of the structural composite beams of a building structure, according to an embodiment of the present invention. As shown, the mezzanine system 400 is used for building the upper floor. This can be facilitated by connecting the PTR profiles 402, 404, and 406 of the mezzanine system 400 with the vertical beams via the H-type structural profile 1301.

FIG. 15 illustrates an exterior front view of building structure 1500 constructed using construction elements 10, 200. The entrance of building structure 1500 includes a horizontal and vertical façade bar which secures therein an Unplasticized Polyvinyl Chloride (UPVS) sliding door 500 via bolts.

FIG. 16 illustrates a cross-section view of the building structure 1500 of FIG. 15. All the walls, floor, and roofs are constructed using the construction elements 10, 200.

Each construction element 10, 200 is assembled in a tongue and groove assembly that allows efficient and accurate construction of walls, ceilings, floors, and roofs, which effectively adapts the structure according to the needs of the end user.

FIG. 16a and FIG. 16b illustrate a cross-section view illustrating a junction in building construction in accordance with an embodiment of the present invention. As shown in FIG. 16a, the wall and the beam form an L-junction using construction elements 10, 200. Further, a steel rectangular tubing of 12 gauge 3″ can be used below the beam. similarly, a T-junction is shown on FIG. 16b.

FIG. 17 illustrates an exterior side view of a building structure built using the kit for construction in accordance with an embodiment of the present invention. The structural profile 100 is anchored to the foundation, and all the side walls of the building structure can be made using the construction elements 10, 200. Building structure 1500 as shown in FIGS. 15-17 not only provides rigidity but also better insulation with enhanced soundproofing.

FIG. 18 illustrates a building structure of 1800 in accordance with an embodiment of the present invention. The construction of façade 1801 and the ground floor 1802 can be quickly built with reduced labor, time and cost, where the entire structure can be constructed in less than 24 hours. The following description relates to a method of constructing a building structure, i.e., constructing walls, ceilings, and floors, in accordance with the present invention.

In an embodiment, the method comprises a step of ground preparation, wherein the ground is leveled by stabilizing soil, followed by marking locations for ground screws based on structural engineering drawings for the length and number of modules. In an embodiment, the method comprises a step of foundation setup, wherein

ground screws are installed as per the structural drawing, depending on the length and the number of modules, and followed by aligning of the depth of the foundation. Further, 6×6 treated wood is used, interlocked with L-shape cuts, and screws and metal plates are used for reinforcement. In an embodiment, 2×6 treated wood is added at predetermined intervals.

In an embodiment, the method comprises a step of modular floor base construction, wherein a structural profile of 100 (as shown in FIG. 5) is laid on the foundation. The structural profile 100 comprises a structural body 101 having a square or rectangular cross-section possessing, on at least one side, a channel 102. The method further includes inserting a prefabricated construction element 10 into channel 102 of the structural profile 100 for floor base construction, wherein channel 102 has a square or rectangular cross-section, with an opening coincident with the width A of the construction element 10, so that the construction element 10 fits into the channel 102. A plurality of construction elements 10, 10′ can be assembled next to one another in a tongue and groove assembly configuration (as shown in FIG. 3), wherein a longitudinal protrusion 70 of the first construction element 10 fits into a longitudinal inlet 60′ of a second construction element 10′. In this manner, each protrusion of the pair of protrusions 30′ of the second construction element 10′ marries with the corresponding recess of the pair of rabbets 40 of the first construction element 10.

This process can be repeated successively with “n” construction element 10, wherein each longitudinal protrusion of the construction element being placed engages the longitudinal protrusion of the construction element previously placed in the assembly until a user-desired floor area is reached in the building structure. Further, in one embodiment, the method comprises placing ¾-inch treated plywood over a structure formed using structural profile 100 and construction element 10, followed by adding a layer of ½ inch plywood for added strength to the modular section.

In an embodiment, the method comprises a step of assembly of a modular frame, wherein the structural profile 100 is erected. The method includes anchoring the structural profile 100 to a foundation or platform through the anchor base 103. In an embodiment, the structural profile 100 is vertically erected in an H-shaped formation, securing the foundation. The method of assembly of the modular frame further includes erecting single-angle steel roof frames using the structural profile 100 and adjusting the structure according to the number of modules. In an embodiment, the H-shaped formation of structural profile 100 can be utilized for the roof frames, securing the modular structure.

In an embodiment, the method comprises a step of wall and roof panel installation, wherein floor panels specific to the base are installed, followed by vertical wall panels up to the roof. The prefabricated construction element 10 is inserted into channel 102 of the erected structural profile 100 wherein channel 102 has a square or rectangular cross-section, with an opening coincident with the width A of the construction element 10, so that the construction element 10 fits into channel 102. In an embodiment, the vertical wall panels comprise “n” number of construction element 10, with longitudinal protrusion of the construction element being engaged with the longitudinal protrusion of the construction element previously placed in the assembly until a user-desired wall is reached up to the roof. The method further includes sealing the joints with tape and insulation. The wall and roof panel installation, in accordance with the present invention, ensures easy assembly and expansion.

In an embodiment, the method comprises a step of installation of windows and doors, wherein windows and doors are fitted as per the drawings plan, followed by sealing with caulking for weatherproofing, especially for glass sections.

In an embodiment, the method comprises a step of roof insulation and covering, wherein 3-inch foam insulation is laid on the roof, topped with ½-inch plywood. Further, a synthetic vapor barrier is added, followed by metal roofing and gutters. In an embodiment, a body 20 of the construction element 10, forming floor base, walls, and/or roof, includes at least one conduit 50 traversing its entire length L, which may be filled with a thermally insulating material. Said conduit 50 may have any cross-sectional configuration, such as square, triangular, round, circular, oval, or polyhedral, among others. Examples of thermally insulating materials include, but are not limited to, polyurethane foam, expanded or extruded polystyrene, expanded perlite, fiberglass, cork, mineral wool, wood shavings, sawdust, straw, and combinations thereof.

In an embodiment, the method comprises a step of interior finishing, wherein the constructed floor base is bifurcated using an interior wall, constructed using designated interlocking panels comprising the construction element 10 and structural profile 100 of the present invention. Further, metal framing is installed for the loft and covered with designated roof pieces.

In an embodiment, the method comprises a step of utility installation, wherein plumbing, electrical systems, and mini-split systems are installed as per designated openings and layout of the modules.

The building constructed using the above-disclosed method advantageously speeds up the assembly process and increases the efficiency of construction, aiding in meeting the demand of the industry. By using tongue-and-groove construction elements and structural profiles designed specifically for this purpose, the task of erecting walls, roofs, and floors in a building structure is significantly simplified. This efficiency of the method translates into time and cost savings, which is especially beneficial for both large-scale projects including residential and commercial constructions. In addition, the precision of precast elements contributes to higher quality and consistency in the final construction process disclosed above, which is also a key advantage in terms of the durability and stability of the structure.

FIG. 19 illustrates a flowchart 1900 illustrating a method of building a structure using the embodiments of this invention. In this method, several steps are utilized to build a structure. The first step 1901 involves building or constructing a solid foundation for the building. This foundational layer provides stability and support. The next step 1902 involves the placement of the structural profile by laying a structural profile on the foundation. Step 1902 involves laying the structural pieces of the building on a foundation. This profile defines the framework of the building.

The next step 1903 comprises inserting a prefabricated construction element into a channel of the structural profile. The prefabricated element insertion involves prefabricated construction elements (like walls or panels) that are inserted into the channels within the structural profile. These pre-made components expedite construction. The next step 1904 is to repeat the process of steps 1902 and 1903, as needed.

The next step 1905 comprises assembling a plurality of construction elements in a tongue and groove assembly configuration. Using the tongue and groove assembly ensures tight fits and structural integrity.

For the next step 1906, plywood is added as needed. The plywood is used to add structural stability. The penultimate step 1907 is constructing the roof. The roof construction involves building the roof atop the assembled structure. Roofing materials, trusses, and insulation contribute to weatherproofing and thermal regulation.

The final step 1908 involves finishing the interior. Typically, the interior finishing includes walls, flooring, fixtures, and aesthetics.

Additionally, we enhance the structure by adding plywood and insulation as needed. Plywood reinforcement involves strategically adding plywood sheets to improve overall structural strength, especially in load-bearing areas. Insulation Integration comprises adding Insulating materials (such as foam or fiberglass) that are incorporated into the construction elements. Insulation enhances energy efficiency and soundproofing. Electrical wiring and plumbing involve electrical wiring and plumbing within the interior space. Wiring provides power, while plumbing ensures water supply and drainage.

In one embodiment, AI and ML are leveraged to improve the methods. Typically, this involves machine learning optimization: Throughout construction, ML algorithms analyze data (sensor data, historical records) to optimize scheduling, resource allocation, and quality control. Artificial Intelligence Decision-Making involves AI systems, powered by neural networks, assisting in design optimization, risk assessment, and quality assurance. Integrating AI and ML can favorably improve efficiency, safety, and overall quality in modern construction practices.

According to the present invention, a faster, less complex, and lower-cost building structure can be constructed compared to the traditional buildings. the building constructed using the present invention eliminates the requirement of 5 to 8 layers and/or elements from traditional buildings in walls and ceilings. this is because the construction element 10, 200 of the present invention already includes insulation and interior and external finishing. Further. the present invention reduces the material components and technical competencies required, which makes the construction less complex. moreover, quick fit assembly of the present invention reduces labor time and cost, wherein an entire structure can be completed by four persons in less than 24 hours.

Further advantages of the present invention are as follows:
reduces the temperature transmission, as the material used for the construction element 10, 200 has much lower temperature transmission than steel.
The H shape of the structural profile allows two Neoposts to fit together, interlocking one on another forming walls.
pre-cut parts and engineered fit reduce on-site tools, activities, and construction waste. E.g. no cutting, wielding, plastering, insulating, nailing, or painting.
Intrinsic color options for varied wood type finishes.
Fast and simple logistics—entire home in standard 20 ft container.
Ultra-low carbon with 95% recycled material blocks and concrete-free compatible design to eliminate metric ton(s) of CO2e per build.
High insulation properties provide a high high-efficiency climate-controlled interior.
Highly durable construction, built to withstand harsh environments such as coastal and mountain regions.
Low maintenance, easy to clean, no repainting required.

### LIST OF FIGURES REFERENCES

10; 200—construction elements
20; 220—body
A—width
H—height
L—length
21, 22; 221, 222—first pair of opposite sides
23, 24; 223, 224—second pair of opposite sides
25, 26; 225, 226—third pair of opposite faces
30; 230—a pair of protrusions
40; 240—a pair of rabbets
50; 250—conduit
60; 260—longitudinal inlet
70; 270—longitudinal protrusion
80—surface finish
90—building structure
100; 300—structural profile
101; 301—structural body
102; 302—channel
103—anchor base
104; 304—wrapping structure
105; 305—structure conduit
400—mezzanine system
402, 404, 406—PTR profile
408—loading element
410—U-type clips

Based on the embodiments described above, it is contemplated that modifications of the described embodiments as well as alternative embodiments will be considered obvious to a person skilled in the art under the present description. It is, therefore, contemplated that the claims encompass such modifications and alternatives that are within the scope of the present invention or their equivalents.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for description and not for limitation. Therefore, while the embodiments herein have been described in terms of preferred embodiments, those skilled in the art will recognize that the embodiments herein can be practiced with modification within the spirit and scope of the appended claims.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A device, comprising:
a body of generally straight parallelepiped shape with a length (L), a width (A), and a height (H), including a first pair of opposite faces, a second pair of opposite faces, and a third pair of opposite faces;
a pair of protrusions located on a face of the first pair of opposite faces, defining a longitudinal inlet;
a pair of rabbets located on another face of the first pair of opposite faces, defining a longitudinal protrusion, wherein the longitudinal protrusion corresponds to the longitudinal inlet; and
at least one conduit traversing the length (L) of the body, wherein the conduit is filled with a thermally insulating material.

22. The device according to claim 21, wherein the conduit has a square, rectangular, circular cross-section.

23. The device according to claim 21, further comprises a surface finish on at least one opposite face of the second pair of opposite faces.

24. The device according to claim 21, wherein the device is a construction element and has a defined and fixed cross-section.

25. The device according to claim 21, wherein the device is extruded.

26. The device according to claim 21, wherein the device is a panel or a block.

27. The device according to claim 21, wherein the device is made of a thermoplastic material.

28. The device according to claim 21, wherein the device is made of a mixture of a thermoplastic material and cellulose fibers.

29. A kit for constructing a building structure, comprising:
at least one structural profile, having, on at least one side, a channel; and.
at least one construction element that fits into the channel of the structural profile, the construction element comprising:
a body of generally straight parallelepiped shape with a length (L), a width (A), and a height (H), including a first pair of opposite faces, a second pair of opposite faces, and a third pair of opposite faces;
a pair of protrusions located on a face of the first pair of opposite faces, defining a longitudinal inlet; and
a pair of rabbets located on another face of the first pair of opposite faces, defining a longitudinal protrusion, wherein the longitudinal protrusion corresponds to the longitudinal inlet.

30. The kit according to claim 29, wherein the structural profile includes a wrapping structure, wherein the wrapping structure further includes at least one structure conduit.

31. The kit according to claim 30, wherein the wrapping structure is made of a thermoplastic material.

32. The kit according to claim 30, wherein the structure conduit is filled with a thermo-insulating material.

33. The kit according to claim 29, wherein the building structure is a wall, roof, or floor.

34. The kit according to claim 29, wherein the channel has an opening coincident with the width (A) of the body of the construction element and the construction element comprises at least one conduit traversing the length (L) of the body and the device has a square, rectangular, circular cross-section.

35. The kit according to claim 30, wherein the conduit of the device is filled with a thermally insulating material.

36. The kit according to claim 30, wherein the construction element comprises a surface finish on at least one opposite face of the second pair of opposite faces.

37. The kit according to claim 30, wherein the construction element has a defined and fixed cross-section and the device is extruded.

38. The kit according to claim 30, wherein the construction element is a panel or a block.

39. The kit according to claim 29, wherein the construction element is made of a thermoplastic material.

40. The kit according to claim 29, wherein the construction element is made from a mixture of a thermoplastic material and cellulose fibers.
